(19) United States
(12) Patent Application Publication
(10) Pub. No.: US 2025/0009024 A1
(43) Pub. Date: Jan. 9, 2025

(54) HEATING ATOMIZATION ASSEMBLY, ATOMIZER, AND AEROSOL GENERATION DEVICE

(71) Applicant: SHENZHEN WOODY VAPES TECHNOLOGY CO., LTD., Shenzhen (CN)

(72) Inventors: Wuyang DENG, Shenzhen (CN); Xinrong HUANG, Shenzhen (CN)

(73) Assignee: SHENZHEN WOODY VAPES TECHNOLOGY CO., LTD., Shenzhen (CN)

(21) Appl. No.: 18/756,486

(22) Filed: Jun. 27, 2024

(30) Foreign Application Priority Data
Jul. 6, 2023 (CN) 202310825044.7

(51) Int. Cl. A24F 40/44; A24F 40/10; A24F 40/42; A24F 40/46; A24F 40/485; A24F 40/50

(52) U.S. Cl. CPC A24F 40/44; A24F 40/10; A24F 40/42; A24F 40/46; A24F 40/485; A24F 40/50

(57) ABSTRACT

A heating atomization assembly, an atomizer, and an aerosol generation device are provided. The heating atomization assembly includes a fixing sleeve made of metal, a heating body, and a liquid absorption member. The heating body covers one end of the fixing sleeve. The fixing sleeve and the heating body cooperatively define an accommodation cavity. One end of the fixing sleeve away from the heating body defines at least one liquid-guiding hole in communication with the accommodation cavity. The heating body defines multiple air-guiding holes extending through the heating body and in communication with the accommodation cavity. The liquid absorption member is disposed in the accommodation cavity and sandwiched between the heating body and the fixing sleeve. The fixing sleeve, the heating body, and the liquid absorption member are detachably assembled and fixed.

### CROSS-REFERENCE TO RELATED APPLICATION

This application claims priority under 35 U.S.C. § 119(a) to and the benefit of Chinese Patent Application No. 202310825044.7, filed Jul. 6, 2023, the entire disclosure of which is incorporated herein by reference.

### TECHNICAL FIELD

The disclosure relates to the technical field of aerosol generation devices, and in particular, to a heating atomization assembly, an atomizer, and an aerosol generation device.

### BACKGROUND

Aerosol generation devices can heat and atomize an aerosol substrate to generate aerosol. Currently, split-type aerosol generation devices mainly consist of an atomizer and a main unit for powering, while in integrated aerosol generation devices, an atomization part and a power supply part are assembled on the same housing.

A battery for powering the atomizer is provided in the main unit. The atomizer includes an atomization core for heating and atomizing. The atomization core generally includes a liquid absorption member and a heating body. When powered, the heating body can heat and atomize a liquid substrate into aerosol for inhalation of a user.

Shortcomings of existing atomization cores are as follows. An atomization core is generally in a shape of cylinder and placed vertically, and is mainly composed of a cylindrical cotton column and heating wires provided on an inner wall of the cotton column. The assembly method is difficult to produce and process, and the heating wires are prone to deformation when placed inside the cotton column, resulting in a high assembly defective rate. Secondly, since the introduction of external airflow is required to generate aerosol flow for inhalation, the atomization core has openings at both the top and bottom for gas flow. The bottom opening design may cause the liquid substrate absorbed in the atomization core to leak out and backflow of condensate after atomization, resulting in that the condensate to drip downwards from a lower opening of the atomization core, thereby contaminating the atomizer. In addition, due to the cylindrical structure, the liquid substrate in the liquid absorption member will have the problem of uneven liquid supply, that is, the amount of the liquid substrate in part of the liquid absorption member above a liquid-guiding hole is less than the amount of the liquid substrate in part of the liquid absorption member below the liquid-guiding hole. Under a high temperature of the heating body, it is easy to generate a burnt taste due to insufficient local liquid supply and the risk of inhaling high-temperature aerosol.

Existing atomization cores may also be block-shaped and horizontally placed inside the atomizer for heating and atomization. However, the existing block-shaped atomization core is mainly composed of a liquid guiding ceramic and a heating body formed on one surface of the liquid guiding ceramic. Firstly, the liquid-guiding effect is relatively poor. Secondly, the manufacturing process is complex and costly. Thirdly, the mounting structure inside the atomizer is complex.

### SUMMARY

In a first aspect, in order to overcome the above-mentioned deficiencies in the related art, the disclose provides a heating atomization assembly. The heating atomization assembly includes a fixing sleeve made of metal, a heating body, and a liquid absorption member. The heating body is detachably provided at one end of the fixing sleeve. The fixing sleeve and the heating body cooperatively define an accommodation cavity, one end of the fixing sleeve away from the heating body defines at least one liquid-guiding hole in communication with the accommodation cavity, and the heating body defines multiple air-guiding holes extending through the heating body. The liquid absorption member is disposed in the accommodation cavity and sandwiched between the heating body and the fixing sleeve.

Further, the heating atomization assembly further includes a locking assembly. The heating body is locked with the fixing sleeve via the locking assembly, and the locking assembly includes a positive pole and a positive-pole ring. The positive pole extends through the heating body, the liquid absorption member, and the fixing sleeve, the positive-pole ring is connected to one end of the positive pole away from the heating body, an insulating ring is disposed between the positive pole and the fixing sleeve, and the positive pole is separated from the fixing sleeve by the insulating ring.

Further, the heating body has a protruding ring at an outer periphery of the heating body, where the protruding ring is attached to an end face of the fixing sleeve, the heating body has a protruding portion that is recessed at the middle of the heating body towards the accommodation cavity and abuts against the liquid absorption member.

Further, the liquid absorption member consists of at least one layer of cotton sheet.

In a second aspect, an atomizer is further provided in the disclosure. The atomizer includes the heating atomization assembly provided in any of embodiments in the first aspect.

Further, the atomizer further includes a liquid-storage bin, an air-guiding member, and the heating atomization assembly. The liquid-storage bin defines a liquid-storage cavity therein for accommodating a liquid substrate. The air-guiding member extends through one end of the liquid-storage bin. An inner end of the air-guiding member defines an opening in communication with the liquid-storage cavity, and the liquid-storage bin defines an air-inlet hole in communication with the air-guiding member. The heating atomization assembly is disposed in the air-guiding member to seal the opening, and one end of the at least one liquid-guiding hole close to the opening is in communication with the liquid-storage cavity, to absorb and heat the liquid substrate in the liquid-storage cavity for atomization.

Further, the atomizer further includes an air-guiding pipe received in the air-guiding member. An outer end of the air-guiding member protrudes outwards to form a nozzle, where one end of the air-guiding pipe is sleeved within the nozzle, and another end of the air-guiding pipe extends to a position above the heating atomization assembly, to communicate the heating atomization assembly with the nozzle, and where the air-guiding pipe, the air-guiding member, and the heating atomization assembly cooperatively define an air-inlet channel that is in communication with both the air-inlet hole and the air-guiding pipe.

Further, the atomizer further includes a positive pole pin and a negative pole pin that both extend through one end of the liquid-storage bin away from the nozzle.

Further, the atomizer further includes an air-adjusting ring and an elastic locking member, where the air-adjusting ring is rotatably disposed at one end of the liquid-storage bin close to the nozzle, the air-adjusting ring defines a through-hole extending through the air-adjusting ring, and after rotation of the air-adjusting ring relative to the liquid-storage bin, the through-hole is at least partially aligned with and in communication with the air-inlet hole, or the through-hole is misaligned with the air-inlet hole to seal the air-inlet hole. The elastic locking member is disposed between the air-adjusting ring and the liquid-storage bin, where the elastic locking member includes a sliding member slidably disposed on the liquid-storage bin and an elastic member disposed between the sliding member and the liquid-storage bin, and the air-adjusting ring defines an arc-shaped groove on an inner wall of the air-adjusting ring, where the arc-shaped groove is operable to be in snap-fit with an outer end of the sliding member.

In a third aspect, an aerosol generation device is further provided in the disclosure. The aerosol generation device includes a main unit for powering and the atomizer provided in any one of the embodiments in the first aspect.

The disclosure has the following beneficial effects.

In the disclosure, the fixing sleeve, the heating body, and the liquid absorption member are detachably assembled and fixed, the production and assembly process is simple. The fixing sleeve is used to support the liquid absorption member and the heating body, thereby avoiding problems such as deformation of the heating body during assembly. Furthermore, one end of the heating atomization assembly defines the liquid-guiding hole, and the heating atomization assembly can be placed horizontally inside an atomization core, so that the liquid substrate can be drawn upwards from bottom to top for atomization, thereby preventing the condensate after atomization from dripping downwards and contaminating the atomizer.

Furthermore, by means of the fixing of the locking assembly, the problems of displacement and falling of the heating body and the liquid absorption member during use are avoided. The fixing sleeve is made of metal, and serves as a conductive negative electrode of the heating body after being connected to the heating body. After the heating atomization assembly is disposed in the atomizer, it only needs to enable the positive pole and the fixing sleeve to be respectively in contact and connection with positive and negative probes in the atomizer. This design eliminates the need for additional wiring, making the installation and connection structure simple and reliable.

In addition, in the atomizer, the heating atomization assembly is directly placed horizontally at the inner end of the air-guiding member, allowing the liquid substrate in the liquid-storage bin to be heated and atomized by the heating atomization assembly, and then directly discharged from an outer end of the air-guiding member. The air-inlet hole is located at one end of the liquid-storage bin and is directly in communication with the air-guiding member. The liquid-storage cavity forms a sealed space, so that the condensate deposited on the air-guiding member can only be reabsorbed and re-heated to be atomized by the heating atomization assembly, preventing the condensate from falling out from the bottom of the liquid-storage bin or entering a lower power supply assembly. Since the air-inlet hole is located at the top, the condensate cannot flow out from the air-inlet hole, preventing contamination.

The heating atomization assembly draws liquid upwards from the bottom to the top to deliver the liquid to the heating body, ensuring uniform liquid supply throughout and avoiding issues of burnt taste and high-temperature aerosol caused by insufficient localized liquid supply.

Additional aspects and advantages of the disclosure will be partially given in the following illustrations, which will become apparent from the following illustrations or learned through the practice of the disclosure.

### BRIEF DESCRIPTION OF THE DRAWINGS

To describe technical solutions in embodiments of the disclosure more clearly, the following briefly introduces the accompanying drawings required for describing the embodiments. Apparently, the accompanying drawings in the following illustrations only illustrate some embodiments of the disclosure. Those of ordinary skill in the art may also obtain other drawings based on these accompanying drawings without creative efforts.

FIG. 1 is an exploded view of a heating atomization assembly in an embodiment.

FIG. 2 is a cross-sectional view of a heating atomization assembly in an embodiment.

FIG. 3 is a schematic view of the heating atomization assembly in FIG. 2, where a liquid absorption member is not illustrated.

FIG. 4 is a schematic view of a heating body in an embodiment.

FIG. 5 is a schematic view of an atomizer in an embodiment.

FIG. 6 is a cross-sectional view of the atomizer in FIG. 5.

FIG. 7 is an enlarged view of the atomizer at frame A in FIG. 6.

FIG. 8 is a cross-sectional view of the atomizer in FIG. 5, from another view.

FIG. 9 is a schematic view of an air-adjusting ring in FIG. 5.

FIG. 10 is an exploded view of the atomizer in FIG. 5.

FIG. 11 is a schematic view of an aerosol generation device in an embodiment.

### DETAILED DESCRIPTION

The technical solutions in the embodiments of the disclosure will be clearly and completely described in the following with reference to the accompanying drawings in the embodiments of the disclosure. Apparently, the described embodiments are merely part of rather than all of the embodiments of the disclosure. All other embodiments obtained by those of ordinary skill in the art based on the embodiments of the disclosure without creative efforts are within the scope of the disclosure.

It should be understood that the terms “comprise”, “include”, and “contain” used in the description and the appended claims, indicate the existence of the described features, integers, steps, operations, elements, and/or components, without excluding the existence or addition of one or more other features, integers, steps, operations, elements, components, and/or combinations thereof.

It should also be understood that the terms used in the description of the disclosure are intended to describe particular embodiments only and are not intended to limit the disclosure. As used in this description and the appended claims, the singular forms “a”, “an”, and “the” are intended to include the plural forms as well, unless the context clearly indicates otherwise.

It will be further understood that the term “and/or” used in this description and the appended claims refers to, and includes, any and all possible combinations of one or more of the items listed in association.

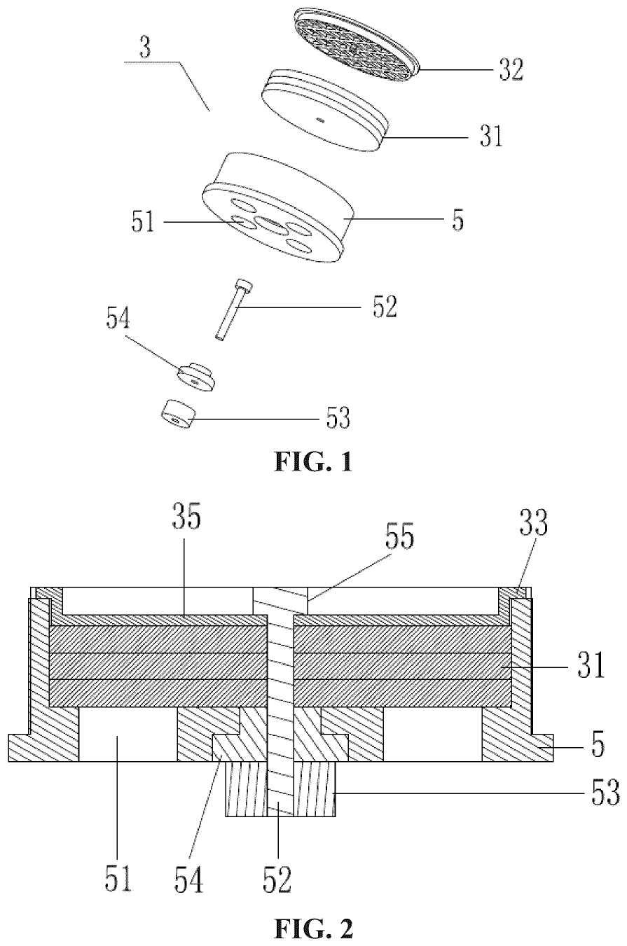

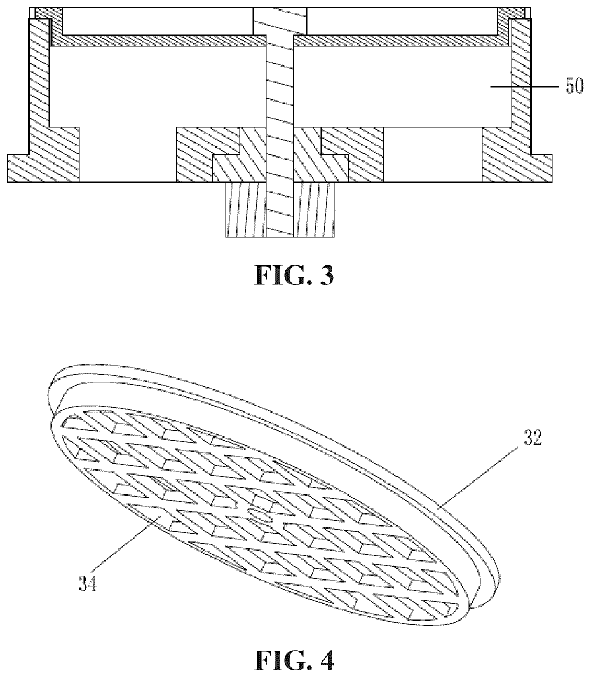

As illustrated in FIGS. 1-4, a heating atomization assembly 3 of the embodiment includes a fixing sleeve 5 made of metal, a liquid absorption member 31, and a heating body 32. One end of the fixing sleeve 5 defines a groove. The heating body 32 detachably covers one end of the fixing sleeve 5 where the groove is located, so that the fixing sleeve 5 and the heating body 32 cooperatively define an accommodation cavity 50. The liquid absorption member 31 is detachably disposed in the accommodation cavity 50, and is sandwiched between the heating body 32 and the fixing sleeve 5. That is, upper and lower surfaces of the liquid absorption member 31 are respectively in contact with the heating body 32 and the fixing sleeve 5. The liquid absorption member 31 is configured to absorb a liquid substrate and transport the liquid substrate upward to the heating body 32, so that the liquid substrate can be heated and atomized by the heating body 32 into aerosol for human inhalation. One end, away from the heating body 32, of the fixing sleeve 5 defines four liquid-guiding holes 51 in communication with the accommodation cavity 50. In the case where the heating atomization assembly 3 is utilized into an atomizer, a liquid substrate in the atomizer can be guided to the liquid absorption member 31 through the liquid-guiding hole 51. The heating body 32 defines multiple air-guiding holes 34 extending through the heating body 32. The aerosol generated by heating and atomizing flows out through the air-guiding hole 34 and comes into contact with the air, thereby allowing the air to carry the aerosol out.

In the above-mentioned embodiments, the fixing sleeve 5, the heating body 32, and the liquid absorption member 31 are detachably assembled and fixed, the production and assembly process is simple. The fixing sleeve 5 is used to support the liquid absorption member 31 and the heating body 32, thereby avoiding problems such as deformation of the heating body during assembly. Furthermore, one end of the heating atomization assembly 3 defines the liquid-guiding hole, and the heating atomization assembly 3 can be placed horizontally inside an atomization core, so that the liquid substrate can be drawn upwards from bottom to top for atomization, thereby preventing the condensate after atomization from dripping downwards and contaminating the atomizer.

Preferably, the heating atomization assembly 3 further includes a locking assembly, where the heating body 32 is locked with the fixing sleeve 5 via the locking assembly. By means of the fixing of the locking assembly, the problems of displacement and falling of the heating body and the liquid absorption member during use are avoided. The locking assembly includes a positive pole 52 and a positive-pole ring 53. The positive pole 52 extends through the heating body 32, the liquid absorption member 31, and the fixing sleeve 5. The positive-pole ring 53 is connected and fixed to one end of the positive pole 52 away from the heating body 32, and preferably via screws. A stop ring 55 protrudes radially from one end of the positive pole 52 close to the heating body 32, so that the heating body 32, the liquid absorption member 31, and the fixing sleeve 5 are locked together under the action of the stop ring 55 and the positive-pole ring 53. An insulating ring 54 is provided between the positive pole 52 and the fixing sleeve 5 to separate the positive pole 52 from the fixing sleeve 5. By utilizing the intermediate contact conduction between the positive pole 52 and the heating body 32, the positive pole 52 may serve as a conductive positive electrode of the heating body 32. The heating body 32 has a protruding ring 33 at an outer periphery of the heating body 32, where the protruding ring 33 is attached to an end face of the fixing sleeve 5. Thus, a stable and reliable contact connection is formed between the fixing sleeve 5 and the outer periphery of the heating body 32. In this embodiment, the fixing sleeve 5 is made of metal, and serves as a conductive negative electrode of the heating body 32 after being connected to the heating body 32. After the heating atomization assembly is disposed in the atomizer, it only needs to enable the positive pole 52 and the fixing sleeve 5 to be respectively in contact and connection with positive and negative probes in the atomizer. This design eliminates the need for additional wiring, making the installation and connection structure simple and reliable.

Preferably, the heating body 32 has a protruding portion 35 at the middle of the heating body 32. The protruding portion protrudes towards the accommodation cavity 50 and abuts against the liquid absorption member 31, thereby avoiding the problem of deformation of the heating body 32 caused by the locking assembly during locking can be avoided, and ensuring that the heating body 32 is in full and close contact with the surface of the liquid absorption member 31.

In one embodiment, the liquid absorption member 31 consists of at least one layer of cotton sheet. By utilizing a multi-layer structure, cotton sheets of different thickness specifications can be selected to form the liquid absorption member, thereby meeting the assembly requirements.

In other embodiments, the heating body 32 is made of porous metal. In some optional embodiments, the porous metal may preferably be metal felt, foam metal, or heating fabric. The metal felt is woven from multiple metal fibers, giving a metal felt body multiple woven holes that facilitate liquid absorption and liquid-guiding. Furthermore, the woven holes enable an inhalation airflow to carry aerosol out of the woven holes during inhalation, thereby further ensuring the aerosol's taste. The foam metal has multiple foam gas holes (i.e., the aforementioned fine holes and/or micro-small holes) with diameters up to the millimeter scale, and most or all of the foam gas holes in the foam metal are in communication with each other, thereby also allowing for liquid guiding and ensuring the aerosol on the foam metal can be carried out as much as possible.

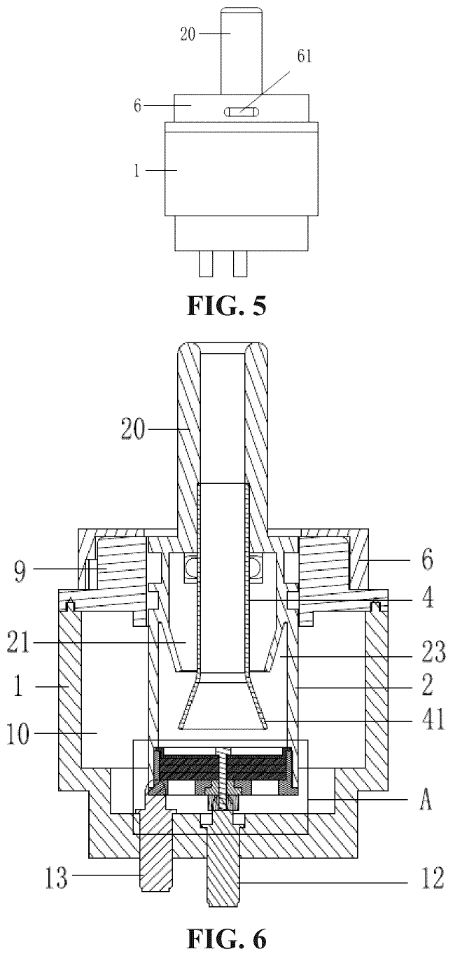

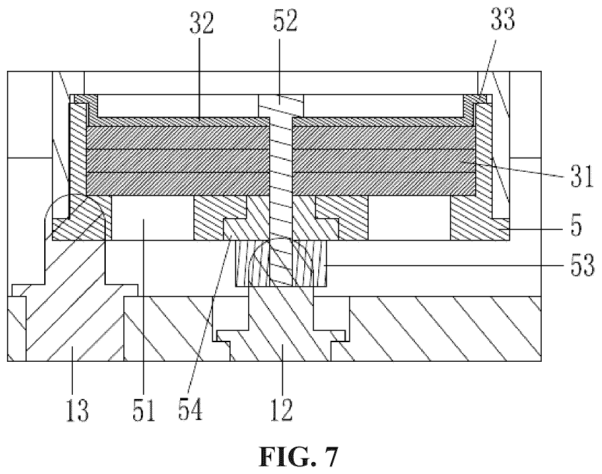

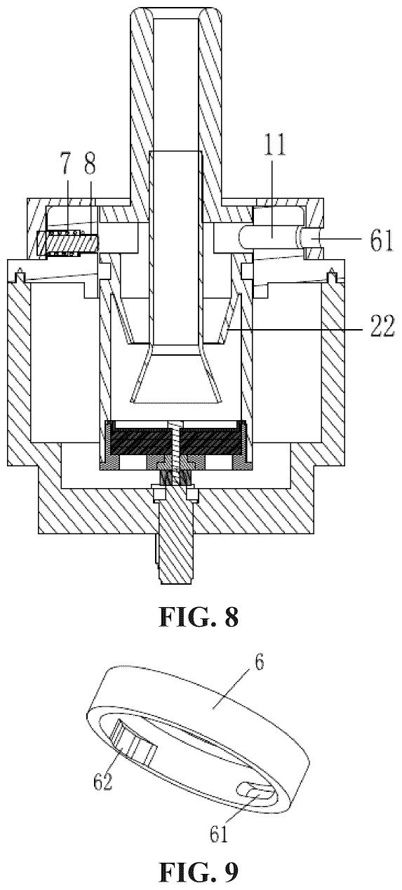

As illustrated in FIGS. 1 to 10, an atomizer 100 of the embodiment includes a liquid-storage bin 1, an air-guiding member 2, and the heating atomization assembly 3 in FIG. 1. The liquid-storage bin 1 defines a liquid-storage cavity 10 therein for accommodating a liquid substrate. The air-guiding member 2 is hollow. The air-guiding member 2 extends through one end of the liquid-storage bin 1. An inner end of the air-guiding member 2 defines an opening in communication with the liquid-storage cavity 10, and an outer end of the air-guiding member 2 protrudes outwards to form a nozzle 20. One end of the liquid-storage bin 1 close to the nozzle 20 defines an air-inlet hole 11 in communication with the air-guiding member 2. The heating atomization assembly 3 is directly placed horizontally at the inner end of the air-guiding member 2 to seal the opening of the inner end of the air-guiding member 2. One end of the liquid-guiding hole 51 close to the opening is in communication with the liquid-storage cavity 10 to absorb and heat the liquid substrate in the liquid-storage cavity 10 for atomization. When inhaling at the nozzle, air entering through the air-inlet hole 11 will flow into the air-guiding member 2. An airflow entering the air-guiding member 2 carries out aerosol generated by the heating atomization assembly 3 through heating and atomization. In this structure, the heating atomization assembly 3 is directly placed horizontally at the inner end of the air-guiding member, allowing the liquid substrate in the liquid-storage bin 1 to be heated and atomized by the heating atomization assembly 3, and then directly discharged from the nozzle at the top. The heating atomization assembly 3 draws liquid upwards from the bottom to the top to deliver the liquid to the heating body 32, ensuring uniform liquid supply throughout and avoiding issues of burnt taste and high-temperature aerosol caused by insufficient localized liquid supply. In addition, the air-inlet hole 11 is located at one end of the liquid-storage bin 1 close to the nozzle and is directly in communication with the air-guiding member. The liquid-storage cavity forms a sealed space, so that the condensate deposited on the air-guiding member 2 can only be reabsorbed and re-heated to be atomized by the heating atomization assembly, preventing the condensate from falling out from the bottom of the liquid-storage bin or entering a lower power supply assembly. Since the air-inlet hole 11 is located at the top, the condensate cannot flow out from the air-inlet hole 11, preventing contamination.

Preferably, the atomizer further includes an air-guiding pipe 4 received in the air-guiding member 2, one end of the air-guiding pipe 4 is sleeved within the nozzle 20, another end of the air-guiding pipe 4 extends to a position above the heating atomization assembly 3, to communicate the heating atomization assembly 3 with the nozzle 20. The air-guiding pipe 4, the air-guiding member 2, and the heating atomization assembly 3 cooperatively define an air-inlet passage 21 that is in communication with both the air-inlet hole 11 and the air-guiding pipe 4. Thus, the air entering through the air-inlet hole 11 will first flow inwards along the air-inlet channel 21 to the heating atomization assembly 3, then flow into the gas-guiding pipe 4 through one end of the gas-guiding pipe 4 close to the heating atomization assembly 3, which can ensure that aerosol generated by heating and atomization can be carried out, preventing the airflow from flowing directly out of the nozzle without contacting the aerosol due to the air-inlet hole 11 being too close to the nozzle 20.

Preferably, one end of the air-guiding pipe 4 located above the heating atomization assembly 3 is flared, with a larger outer opening and a smaller inner opening, allowing better airflow and accommodating more aerosol by enlarging the orifice. A tapered cone 22 is provided at an inner wall of the air-guiding member 2, and surrounds and is spaced apart from the air-guiding pipe 4. The tapered cone 22 and the inner wall of the air-guiding member 2 cooperatively define a liquid-blocking groove 23 with an opening facing the heating atomization assembly 3, which can prevent condensate from flowing out to the air-inlet hole 11. This means that when the atomizer is tilted, the condensate on the atomization core will be blocked and stored in the liquid-blocking groove 23, thereby avoiding the issue of condensate spilling out.

Preferably, the atomizer also includes a positive pole pin 12 and a negative pole pin 13 that both extend through one end of the liquid-storage bin 1 away from the nozzle 20. The positive pole pin 12 abuts against the positive-pole ring 53, and the negative pole pin 13 abuts against the fixing sleeve 5, thus establishing an electrical connection between the heating body 32 and an external power source. Additionally, the positions of the fixing sleeve 5 and the positive-pole ring 53 are fixed, ensuring that the electrical connection is stable and reliable.

Preferably, the atomizer further includes a gas-adjusting ring 6. The gas-adjusting ring 6 is rotatably disposed at one end of the liquid-storage bin 1 close to the nozzle 20. The air-adjusting ring 6 defines a through-hole 61 extending through the air-adjusting ring 6. After rotation of the gas-adjusting ring 6 relative to the liquid-storage bin 1, the through-hole 61 is at least partially aligned with and in communication with the air-inlet hole 11, or the through-hole 61 is misaligned with the air-inlet hole 11 to seal the air-inlet hole 11. That is, after rotation of the gas-adjusting ring 6, there are three states of opening and closing of the air-inlet hole, including a fully open state formed when the entire air-inlet hole 11 is in communication with the through-hole 61, a half-open and half-closed state formed when the air-inlet hole 11 is in partial communication with the through-hole 61, and a fully closed state formed when the entire air-inlet hole 11 is misaligned with the through-hole 61.

Preferably, the atomizer further includes an elastic locking member disposed between the gas-adjusting ring 6 and the liquid-storage bin 1. The elastic locking member includes a sliding member 7 slidably disposed on the liquid-storage bin 1 and an elastic member 8 disposed between the sliding member 7 and the liquid-storage bin 1. The gas-adjusting ring 6 defines an arc-shaped groove 62 on an inner wall of the gas-adjusting ring 6, and the arc-shaped groove 62 is operable to be in snap-fit with an outer end of the sliding member 7. When the arc-shaped groove 62 aligns with the sliding member 7, the sliding member 7 snaps into the arc-shaped groove 62 under the action of the elastic member 8, creating a restricting effect. When a certain pressure is applied to make the air-adjusting ring 6 rotate, the characteristics of the arc-shaped groove 62 allow the sliding member 7 to slide out of the arc-shaped groove 62 and compress the elastic member 8, thus enabling the rotation of the air-adjusting ring 6. It is understood that the elastic member 8 is preferably a spring.

Preferably, an upper end of the liquid-storage bin 1 defines an opening, and an upper cover 9 covers the opening. The air-inlet hole 11 and the elastic locking member are positioned within the upper cover 9. The nozzle 20 extends vertically through the center of the upper cover 9, and the air-adjusting ring 6 is rotatably disposed around an outer periphery of the upper cover 9.

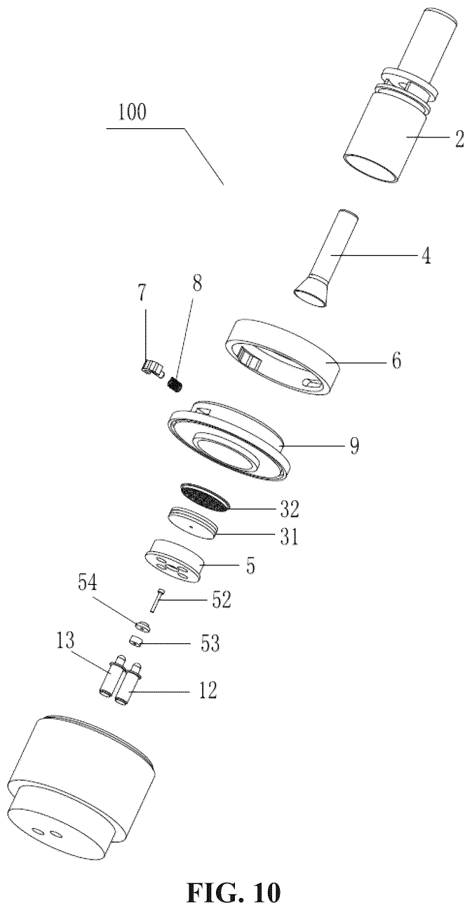

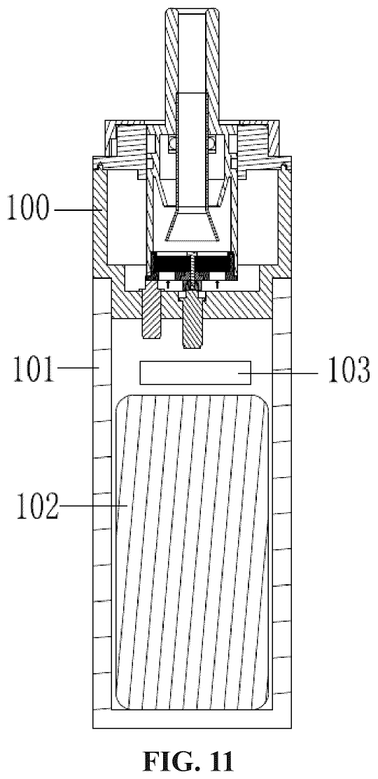

As illustrated in FIG. 11, the disclosure further provides an aerosol generation device. The aerosol generation device includes the atomizer 100 in FIG. 10 and a main unit disposed at a lower end of the atomizer 100 and configured to power the atomizer 100.

The main unit includes a housing 101, a battery 102 disposed inside the housing 101, and a circuit board 103 electrically connected to the battery 102. The circuit board 103 is electrically connected to both the positive pole pin 12 and the negative pole pin 13, thereby using the battery 102 to supply power to the atomizing core.

The foregoing illustrations are merely specific embodiments of the disclosure, but are not intended to limit the scope of protection of the disclosure. Any equivalent modification or replacement readily figured out by a person skilled in the art within the technical scope disclosed in the disclosure shall fall within the scope of protection of the disclosure. Therefore, the scope of protection of the disclosure should be determined by the scope of protection of the claims.

What is claimed is:

1. A heating atomization assembly, comprising:
a fixing sleeve made of metal;
a heating body detachably provided at one end of the fixing sleeve, wherein the fixing sleeve and the heating body cooperatively define an accommodation cavity, one end of the fixing sleeve away from the heating body defines at least one liquid-guiding hole in communication with the accommodation cavity, and the heating body defines a plurality of air-guiding holes extending through the heating body; and
a liquid absorption member disposed in the accommodation cavity and sandwiched between the heating body and the fixing sleeve.

2. The heating atomization assembly of claim 1, further comprising a locking assembly, wherein the heating body is locked with the fixing sleeve via the locking assembly, and the locking assembly comprises a positive pole and a positive-pole ring, wherein the positive pole extends through the heating body, the liquid absorption member, and the fixing sleeve, the positive-pole ring is connected to one end of the positive pole away from the heating body, an insulating ring is disposed between the positive pole and the fixing sleeve, and the positive pole is separated from the fixing sleeve by the insulating ring.

3. The heating atomization assembly of claim 2, wherein the heating body has a protruding ring at an outer periphery of the heating body, wherein the protruding ring is attached to an end face of the fixing sleeve, the heating body has a protruding portion at the middle of the heating body, wherein the protruding portion protrudes towards the accommodation cavity and abuts against the liquid absorption member.

4. The heating atomization assembly of claim 1, wherein the liquid absorption member consists of at least one layer of cotton sheet.

5. An atomizer, comprising a heating atomization assembly and an upper cover connected to the heating atomization assembly, wherein the heating atomization assembly comprises:
a fixing sleeve made of metal;
a heating body detachably provided at one end of the fixing sleeve, wherein the fixing sleeve and the heating body cooperatively define an accommodation cavity, one end of the fixing sleeve away from the heating body defines at least one liquid-guiding hole in communication with the accommodation cavity, and the heating body defines a plurality of air-guiding holes extending through the heating body; and
a liquid absorption member disposed in the accommodation cavity and sandwiched between the heating body and the fixing sleeve.

6. The atomizer of claim 5, further comprising:
a liquid-storage bin defining a liquid-storage cavity therein for accommodating a liquid substrate;
an air-guiding member extending through one end of the liquid-storage bin, wherein an inner end of the air-guiding member defines an opening in communication with the liquid-storage cavity, and the liquid-storage bin defines an air-inlet hole in communication with the air-guiding member; and
the heating atomization assembly, wherein the heating atomization assembly is disposed in the air-guiding member to seal the opening, and one end of the at least one liquid-guiding hole close to the opening is in communication with the liquid-storage cavity, to absorb and heat the liquid substrate in the liquid-storage cavity for atomization.

7. The atomizer of claim 6, further comprising an air-guiding pipe received in the air-guiding member, wherein an outer end of the air-guiding member protrudes outwards to form a nozzle, wherein one end of the air-guiding pipe is sleeved within the nozzle, and another end of the air-guiding pipe extends to a position above the heating atomization assembly, to communicate the heating atomization assembly with the nozzle, and wherein the air-guiding pipe, the air-guiding member, and the heating atomization assembly cooperatively define an air-inlet channel that is in communication with both the air-inlet hole and the air-guiding pipe.

8. The atomizer of claim 7, further comprising a positive pole pin and a negative pole pin that both extend through one end of the liquid-storage bin away from the nozzle.

9. The atomizer of claim 8, further comprising an air-adjusting ring and an elastic locking member, wherein the air-adjusting ring is rotatably disposed at one end of the liquid-storage bin close to the nozzle, the air-adjusting ring defines a through-hole extending through the air-adjusting ring, and after rotation of the air-adjusting ring relative to the liquid-storage bin, the through-hole is at least partially aligned with and in communication with the air-inlet hole, or the through-hole is misaligned with the air-inlet hole to seal the air-inlet hole; and the elastic locking member is disposed between the air-adjusting ring and the liquid-storage bin, wherein the elastic locking member comprises a sliding member slidably disposed on the liquid-storage bin and an elastic member disposed between the sliding member and the liquid-storage bin, and the air-adjusting ring defines an arc-shaped groove on an inner wall of the air-adjusting ring, wherein the arc-shaped groove is operable to be in snap-fit with an outer end of the sliding member.

10. The atomizer of claim 6, wherein one end of the liquid-storage bin defines an opening, and the upper cover covers the opening.

11. The atomizer of claim 5, further comprising a locking assembly, wherein the heating body is locked with the fixing sleeve via the locking assembly, and the locking assembly comprises a positive pole and a positive-pole ring, wherein the positive pole extends through the heating body, the liquid absorption member, and the fixing sleeve, the positive-pole ring is connected to one end of the positive pole away from the heating body, an insulating ring is disposed between the positive pole and the fixing sleeve, and the positive pole is separated from the fixing sleeve by the insulating ring.

12. The atomizer of claim 11, wherein the heating body has a protruding ring at an outer periphery of the heating body, wherein the protruding ring is attached to an end face of the fixing sleeve, the heating body has a protruding portion at the middle of the heating body, wherein the protruding portion protrudes towards the accommodation cavity and abuts against the liquid absorption member.

13. The atomizer of claim 5, wherein the liquid absorption member consists of at least one layer of cotton sheet.

14. An aerosol generation device, comprising a main unit for powering and an atomizer comprising a heating atomization assembly, wherein the heating atomization assembly comprises:
a fixing sleeve made of metal;
a heating body detachably provided at one end of the fixing sleeve, wherein the fixing sleeve and the heating body cooperatively define an accommodation cavity, one end of the fixing sleeve away from the heating body defines at least one liquid-guiding hole in communication with the accommodation cavity, and the heating body defines a plurality of air-guiding holes extending through the heating body; and
a liquid absorption member disposed in the accommodation cavity and sandwiched between the heating body and the fixing sleeve.

15. The aerosol generation device of claim 14, further comprising a locking assembly, wherein the heating body is locked with the fixing sleeve via the locking assembly, and the locking assembly comprises a positive pole and a positive-pole ring, wherein the positive pole extends through the heating body, the liquid absorption member, and the fixing sleeve, the positive-pole ring is connected to one end of the positive pole away from the heating body, an insulating ring is disposed between the positive pole and the fixing sleeve, and the positive pole is separated from the fixing sleeve by the insulating ring.

16. The aerosol generation device of claim 15, wherein the heating body has a protruding ring at an outer periphery of the heating body, wherein the protruding ring is attached to an end face of the fixing sleeve, the heating body has a protruding portion at the middle of the heating body, wherein the protruding portion protrudes towards the accommodation cavity and abuts against the liquid absorption member.

17. The aerosol generation device of claim 14, wherein the liquid absorption member consists of at least one layer of cotton sheet.
